(19) United States
(12) Patent Application Publication
(10) Pub. No.: US 2022/0164845 A1
(43) Pub. Date: May 26, 2022

(54) NETWORK SYSTEM FOR PLACING, RECEIVING AND FULFILLING CUSTOMIZED ORDERS FOR HOOKAH PIPES

(71) Applicant: Michael Bannout, North Bergen, NJ (US)

(72) Inventor: Michael Bannout, North Bergen, NJ (US)

(21) Appl. No.: 17/103,115

(22) Filed: Nov. 24, 2020

(51) Int. Cl. G06Q 30/06; G06Q 10/08

(52) U.S. Cl. CPC G06Q 30/0621; G06Q 10/083; G06Q 30/0639; G06Q 30/0633

(57) ABSTRACT

A computerized network system is configured for placing, receiving and fulfilling customized orders for hookah pipes, along with selected pipe accessories, supplies and smoking materials, delivered to customers in a ready-to-smoke configuration. The network software comprises the network software comprises a downloadable, native Customer App, which runs on the customer pc devices, a downloadable, native Supplier App, which runs on the supplier pc devices, and a Web App, which runs on a network website.

### FIELD OF INVENTION

The present invention relates to the general field of computerized systems for placing, receiving and fulfilling orders for customized merchandise, and more particularly to such systems that deliver the orders in ready-to-use form.

### BACKGROUND OF THE INVENTION

While various computerized systems for receiving and fulfilling orders for customized merchandise are known in the art, all of these systems require the consumer to take actions to render the merchandise ready for use. On the other hand, there is considerable value in providing the convenience of delivering a customized product to a consumer in a form that it is immediately ready for use upon delivery of the merchandise. This is particularly true for the purchase of hookah pipes, because hookah smokers are typically accustomed to hookah parlors, where the pipes are provided to customers with the water, tobacco/shisha, igniting charcoals and hoses already in place, so that the pipe is ready to smoke immediately. The present invention affords this same level of convenience to at-home hookah smokers.

### SUMMARY OF THE INVENTION

The present invention is a computerized network system for placing, receiving and fulfilling customized orders for hookah pipes, and for delivering hookah pipes, along with selected pipe accessories, supplies and smoking materials, to customers in a ready-to-smoke configuration.

The network hardware comprises multiple customer personal computing (pc) devices, along with multiple supplier pc devices, both of which connect to a network server through a network connection, which can be an internet or cloud connection. The network software comprises a downloadable, native Customer App, which runs on the customer pc devices, a downloadable, native Supplier App, which runs on the supplier pc devices, and a Web App, which runs on a network website.

The Customer App is configured to receive from the customers the customized orders for the hookah pipes, which orders specify pipe models, pipe accessories, pipe supplies, and smoking materials. After the customer places the customized orders, the Web App is configured to receive the orders through the Customer App and to select from a supplier database a local supplier in proximity to the customers. The Web App is configured to refer the customized orders to the selected local supplier through the Supplier App.

The Supplier App is configured to direct the local suppliers, upon receipt and acceptance of the customized orders, to assemble the hookah pipes, including the selected pipe accessories, pipe supplies and smoking materials, in a ready-to-use configuration, and to deliver the ready-to-smoke hookah pipes to the customers. In practical terms, this would involve setting up the pipe, bowl and hoses, filling the pipe with water, putting tobacco/shisha in the bowl, and placing a charcoal briquette on top of the tobacco/shisha so that it is ready to be lit.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic diagram of an exemplary network system according to one embodiment of the present invention;

FIG. 2 is a diagram of an exemplary menu for customized orders, including selections for hookah models, pipe accessories, pipe supplies, and smoking materials;

FIG. 3A is a diagram of an exemplary first customer order from the menu depicted in FIG. 2;

FIG. 3B is a diagram of an exemplary second customer order from the menu depicted in FIG. 2; and

FIG. 4 is a flow chart of an exemplary method of using the network system to place, receive and fulfill the customized hookah pipe orders.

### DETAILED DESCRIPTION OF THE PREFERRED EMBODIMENT

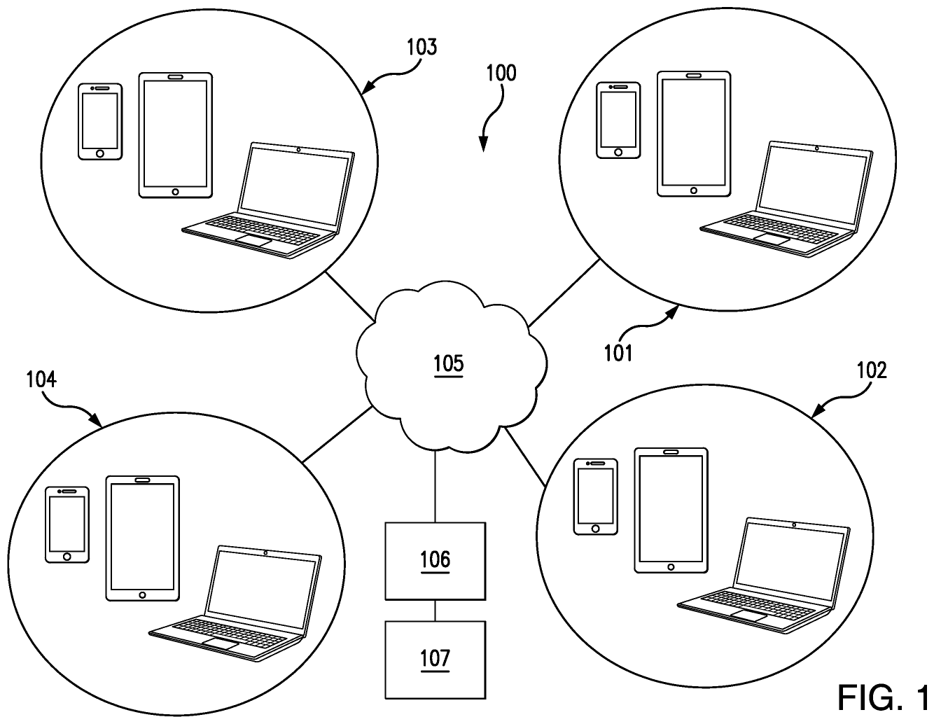

Referring to FIG. 1, the exemplary network system 100 of one embodiment of the present invention comprises the pc devices of Customer #1 101, the pc devices of Customer #2 102, the pc devices of Supplier #1 103, and the pc devices of Supplier #2 104. These pc devices are interconnected through the network connection 105 to the network server 106, which in turn connects to the supplier database 107.

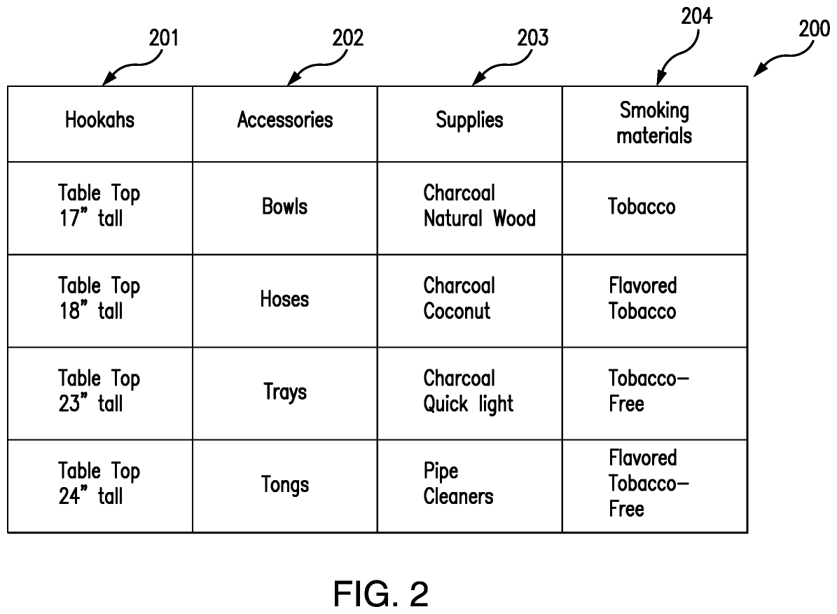

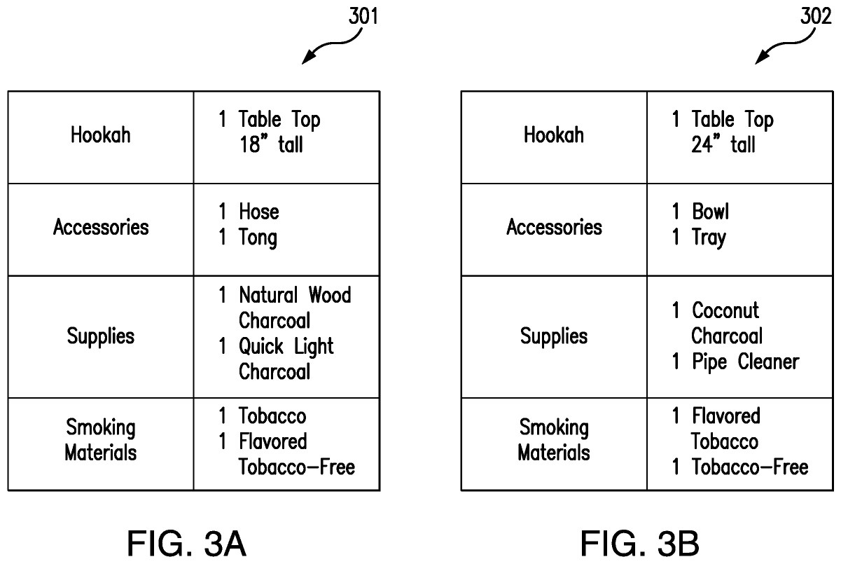

Referring to FIG. 2, an exemplary menu 200 on the network website offers a selection of different hookah models 201, accessories 202, supplies 203, and smoking materials 204. FIG. 3A displays an exemplary customized order 301 placed by Customer #1 101, while FIG. 3B shows an exemplary customized order 302 placed by Customer #2 102. Both orders would be placed using the Customer App.

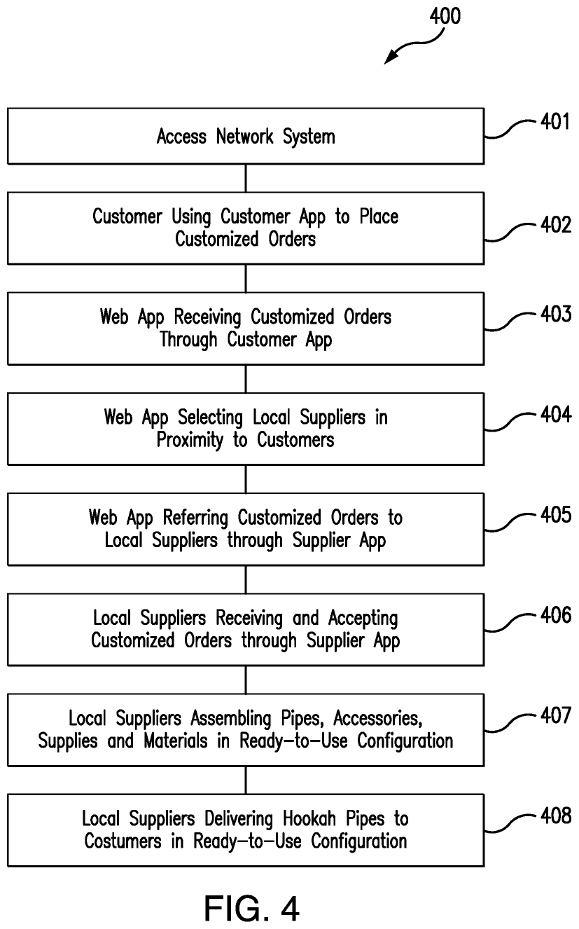

Referring to FIG. 4, a flow chart 400 is depicted for an exemplary method of using the network system to place, receive and fulfill the customized hookah pipe orders according to one embodiment of the present invention. The customers access the network system 401 using the Customer App, and then use the Customer App to place customized orders 402. The Web App receives the customized orders 403 and selects local suppliers from the supplier database 404, based on their proximity to the customers. The Web App then refers the customized orders to the selected local suppliers 405 through the Supplier App.

Through the Supplier App, the local suppliers receive and accept the customized orders 406, and then assemble the hookah pipes, accessories, supplies and smoking materials in a ready-to-smoke configuration 407, in which configuration the pipes are delivered by the local suppliers to the customers.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A computerized network system for placing, receiving and fulfilling customized orders from customers for hookah pipes, the network system comprising:
network hardware, comprising multiple customer pc devices, multiple supplier pc devices, and a network server, wherein the customer pc devices and the supplier pc devices connect to the network server through a network connection;
network software, comprising a downloadable, native Customer App, which runs on the customer pc devices, a downloadable, native Supplier App, which runs on the supplier pc devices, and a Web App, which runs on a network website;
wherein the Customer App is configured to receive from the customers the customized orders for the hookah pipes, and wherein the customized orders specify pipe models, pipe accessories, pipe supplies, and smoking materials;
wherein the Web App is configured to receive the customized orders from the customers through the Customer App and to select from a supplier database local suppliers in proximity to the customers and to refer the customized orders to the local suppliers through the Supplier App; and
wherein the Supplier App is configured to direct the local suppliers, upon receipt acceptance of the customized orders, to assemble the hookah pipes, including the pipe accessories, the pipe supplies, and the smoking materials, in a ready-to-use configuration, and to deliver the hookah pipes to the customers.

2. A method of using the network system according to claim 1, to place, receive and fulfill the customized orders from the customers for the hookah pipes, the method comprising the following steps:
(a) the customers using the Customer App to place the customized orders by selecting the pipe models, the pipe accessories, the pipe supplies, and the smoking materials;
(b) the Web App receiving the customized orders from the customers through the Customer App;
(c) the Web App selecting the local suppliers in proximity to the customers;
(d) the Web App referring the customized orders to the local suppliers through the Supplier App;
(e) the local suppliers receiving and accepting the customized orders through the Supplier App;
the local suppliers assembling the hookah pipes, including the pipe accessories, the pipe supplies, and the smoking materials, in a ready-to-use configuration; and
(g) the local suppliers delivering the hookah pipes to the customers in the ready-to-use configuration.
